(19) United States
(12) Patent Application Publication
(10) Pub. No.: US 2026/0059085 A1
(43) Pub. Date: Feb. 26, 2026

(54) METHOD OF GENERATING SPATIAL VIDEO, METHOD OF PLAYING SPATIAL VIDEO, ELECTRONIC DEVICE, AND STORAGE MEDIUM

(71) Applicant: Beijing Zitiao Network Technology Co., Ltd., Beijing (CN)

(72) Inventors: Jingsong LIU, Beijing (CN); Chao HU, Beijing (CN); Jianyong CUI, Beijing (CN)

(21) Appl. No.: 19/305,248

(22) Filed: Aug. 20, 2025

(30) Foreign Application Priority Data
Aug. 20, 2024 (CN) 202411147404.3

(51) Int. Cl. H04N 13/161; H04N 19/172; H04N 19/176; H04N 19/423; H04N 19/70

(52) U.S. Cl. CPC H04N 13/161; H04N 19/172; H04N 19/176; H04N 19/423; H04N 19/70

(57) ABSTRACT

The present disclosure provides a method of generating a spatial video, a method of playing a spatial video, an electronic device, and a storage medium. The method of generating a spatial video includes: shooting a first frame queue by a first camera and shooting a second frame queue by a second camera, wherein the first frame queue includes at least one first-eye video frame, and the second frame queue includes at least one second-eye video frame; performing encoding processing on the first-eye video frame and the second-eye video frame to obtain media data of a target spatial video; and generating a target video file of the target spatial video according to the media data and the codec specific data of the target spatial video, wherein the codec specific data includes first-eye codec specific data and second-eye codec specific data.

### CROSS-REFERENCE TO RELATED APPLICATION(S)

The present application claims priority to Chinese Patent Application No. 202411147404.3, filed on Aug. 20, 2024, which is incorporated herein by reference in its entirety as a part of the present application.

### TECHNICAL FIELD

Embodiments of the present disclosure relate to the technical field of computers, and more particularly to a method of generating a spatial video, a method of playing a spatial video, an apparatus, an electronic device, a storage medium, and a program product.

### BACKGROUND

For spatial video, especially for multi-view stitching spatial video, the Joint Collaborative Team on 3D Video Coding Extensions (JCT-3V) was established, and in 2014 it published a High Efficiency Video Coding standard extension MV-HEVC for spatial multi-view video. MV-HEVC stores difference information through the main view (Hero Eye) auxiliary view, which can better improve storage efficiency and encode performance.

However, at present, the ability to generate and play MV-HEVC spatial video is not available in Android system.

### SUMMARY

According to a first aspect, an embodiment of the present disclosure provides a method of generating a spatial video, including:
shooting a first frame queue by a first camera and shooting a second frame queue by a second camera, where the first frame queue includes at least one first-eye video frame, and the second frame queue includes at least one second-eye video frame;
performing encoding processing on the first-eye video frame and the second-eye video frame to obtain media data of a target spatial video; and
generating a target video file of the target spatial video according to the media data and the codec specific data of the target spatial video, where the codec specific data includes first-eye codec specific data and second-eye codec specific data.

In a second aspect, an embodiment of the present disclosure further provides a method of playing a spatial video, including:
obtaining codec specific data and media data in a target video file, where the target video file is a video file of a target spatial video, and the codec specific data includes first-eye codec specific data and second-eye codec specific data;
performing decoding processing on the media data according to the codec specific data to obtain a first-eye video stream and a second-eye video stream, where video frames on same positions of the first-eye video stream and the second-eye video stream have timestamps that match with each other; and
playing the first-eye video stream on a first-eye display screen and playing the second-eye video stream on a second-eye display screen, where the first-eye video stream is played synchronously with the second-eye video stream.

According to a third aspect, an embodiment of the present disclosure further provides an apparatus for generating a spatial video, including:
a shooting module configured to shoot a first frame queue by a first camera and shooting a second frame queue by a second camera, where the first frame queue includes at least one first-eye video frame, and the second frame queue includes at least one second-eye video frame;
an encoding module configured to perform encoding processing on the first-eye video frame and the second-eye video frame to obtain media data of a target spatial video; and
a generation module configured to generate a target video file of the target spatial video according to the media data and codec specific data of the target spatial video, where the codec specific data includes first-eye codec specific data and second-eye codec specific data.

According to a fourth aspect, an embodiment of the present disclosure further provides an apparatus for playing spatial video, including:
an obtaining module configured to obtain codec specific data and media data in a target video file, where the target video file is a video file of a target spatial video, and the codec specific data includes first-eye codec specific data and second-eye codec specific data;
a decoding module configured to perform decoding processing on the media data according to the codec specific data to obtain a first-eye video stream and a second-eye video stream, where video frames on same positions of the first-eye video stream and the second-eye video stream have timestamps that match with each other; and
a display module configured to play the first-eye video stream on a first-eye display screen and play the second-eye video stream on a second-eye display screen, where the first-eye video stream is played synchronously with the second-eye video stream.

According to a fifth aspect, an embodiment of the present disclosure further provides an electronic device, including: at least one processor; and a memory communicatively connected to the at least one processor, where the at least one processor is configured to execute computer program stored in the memory to perform the method of generating the spatial video or the method of playing the spatial video according to the embodiment of the present disclosure.

According to a sixth aspect, an embodiment of the present disclosure further provides a computer-readable storage medium, where computer instructions are stored on the computer-readable storage medium to cause at least one processor to execute the method of generating the spatial video or the method of playing the spatial video according to the embodiment of the present disclosure.

According to a seventh aspect, an embodiment of the present disclosure further provides a computer program product in which, when the computer program product is executed by a computer, the computer implements the method of generating the spatial video or the method of playing the spatial video according to the embodiment of the present disclosure.

### BRIEF DESCRIPTION OF DRAWINGS

The above and other features, advantages, and aspects of various embodiments of the present disclosure will become more apparent when taken in conjunction with the accompanying drawings and referring to the following detailed description. Throughout the drawings, the same or similar reference numerals denote the same or similar elements. It should be understood that the drawings are schematic and that originals and elements are not necessarily drawn to scale.

FIG. 1 is a schematic flowchart of a method of generating a spatial video according to an embodiment of the present disclosure.

FIG. 2 is a schematic flowchart of another method of generating a spatial video according to an embodiment of the present disclosure.

FIG. 3 is a schematic diagram of a process of generating a spatial video according to an embodiment of the present disclosure.

FIG. 4 is a schematic flowchart of a method of playing a spatial video according to an embodiment of the present disclosure.

FIG. 5 is a schematic diagram of a process of playing a spatial video according to an embodiment of the present disclosure.

FIG. 6 is a structural block diagram of an apparatus for generating a spatial video according to an embodiment of the present disclosure.

FIG. 7 is a structural block diagram of an apparatus for playing a spatial video according to an embodiment of the present disclosure.

FIG. 8 is a schematic structural diagram of an electronic device according to an embodiment of the present disclosure.

### DETAILED DESCRIPTION

Embodiments of the present disclosure will be described in more detail below with reference to the accompanying drawings. While certain embodiments of the present disclosure are shown in the drawings, it should be understood that the present disclosure may be embodied in various forms and should not be construed as limited to the embodiments set forth herein, but are provided for a more thorough and complete understanding of the present disclosure. It should be understood that the drawings and embodiments of the present disclosure are for illustrative purposes only, and are not intended to limit the scope of protection of the present disclosure.

It should be understood that the various steps described in the method embodiments of the present disclosure may be performed in different orders, and/or in parallel. Furthermore, method embodiments may include additional steps and/or omit performing the illustrated steps. The scope of the present disclosure is not limited in this respect.

As used herein, the term “includes” and variations thereof are open-encompassing, i.e., “including but not limited to”. The term “based on” is “based at least in part on”. The term “an embodiment” means “at least one embodiment”; the term “another embodiment” means “at least one additional embodiment”; The term “some embodiments” means “at least some embodiments”. Relevant definitions of other terms will be given in the following description.

It should be noted that the concepts such as “first” and “second” mentioned in the present disclosure are only used to distinguish different apparatuses, modules, or units, and are not used to limit the order or interdependence of functions performed by these apparatuses, modules, or units.

It should be noted that the modifications of “one” and “a plurality” mentioned in the present disclosure are illustrative and not limiting, and should be understood by those skilled in the art as “one or more” unless otherwise explicitly indicated in the context.

The names of messages or information interacted between multiple devices in embodiments of the present disclosure are for illustrative purposes only, and are not intended to limit the scope of these messages or information.

It can be understood that the data involved in this technical solution (including but not limited to the data itself, the acquisition or use of data) should comply with the requirements of corresponding laws, regulations and relevant provisions.

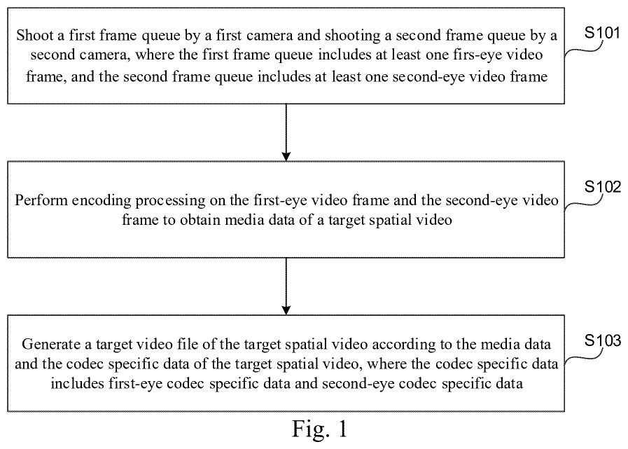

FIG. 1 is a schematic flowchart of a method of generating a spatial video according to an embodiment of the present disclosure. The method may be performed by an apparatus for generating a spatial video, where the apparatus may be implemented by software and/or hardware, may be configured in an electronic device, typically in a Virtual Reality (VR) device, a mobile phone or a tablet. The method of generating a spatial video according to an embodiment of the present disclosure is applicable to a scene in which a spatial video is shot, for example, a scene in which a spatial video is shot by using an electronic device having an Android system as operating system. As shown in FIG. 1, the method of generating the spatial video according to the present embodiment may include the following steps.

In S101, a first frame queue is shot by a first camera, and a second frame queue is shot by a second camera, where the first frame queue includes at least one first-eye video frame, and the second frame queue includes at least one second-eye video frame.

The first camera and the second camera may be two different cameras. The first camera may be used to shoot the first-eye video frame of the target spatial video, and the second camera may be used to shoot the second target space of the target spatial video. The first camera and the second camera may be configured in an electronic device currently installed in application. For example, the first-eye video frame and the second-eye video frame of the target spatial video may be shot synchronously by different cameras in of the electronic device to which the current application is installed. Alternatively, the first camera and the second camera may be configured independently of the electronic device to which the current application is installed. For example, the first-eye video frame and the second-eye video frame of the target spatial video may be shot by shooting apparatus having a communication connection with electronic device to which the current application is installed. The shooting apparatus may be configured with at least two cameras including a first camera and a second camera, and different cameras may be used to capture image at different viewpoints. Exemplarily, the first camera may be used to simulate the vision of one of the left eye and the right eye for image acquisition, and the second camera may be used to simulate the vision of the other of the left eye and the right eye for image acquisition to shoot a target spatial video generating a stereoscopic visual effect.

The first frame queue may be a frame queue composed of first-eye video frame, the first frame queue may include at least one first-eye video frame, and each first-eye video frame is arranged in the first frame queue according to the sequence of shooting. The second frame queue may be a frame queue composed of a second-eye video frame, the second frame queue may include at least one second-eye video frame, and each second-eye video frame is arranged in the second frame queue according to the sequence of shooting.

The first-eye video frame may be video frame shot by the first camera by simulating the viewpoint of one eye. During subsequent video playback, the first-eye video frame may be displayed on the display screen corresponding to the eye. The second-eye video frame may be the video frame shot by the second camera by simulating the viewpoint of the other eye. Exemplarily, the first-eye video frame is left-eye video frame, and the second-eye video frame is right-eye video frame; Alternatively, the first-eye video frame is right-eye video frame, and the second-eye video frame is left-eye video frame, which may be set as needed. In the following description, the case in which the first-eye video frame is a left-eye video frame and the second-eye video frame is a right-eye video frame is taken as an example. In this case, the first camera may be left-eye camera, the second camera may be right-eye camera, the first frame queue may be a left-eye frame queue, and the second frame queue may be a right-eye frame queue.

In the present embodiment, when the target spatial video is generated, the first frame queue of the target spatial video may be shot by the first camera, and the second frame queue of the target spatial video may be shot by the second camera.

For example, when it is detected that the current user performs a shooting operation of a spatial video, in response to the shooting operation, left-eye camera and right-eye camera may be used to synchronously shoot, specifically, the left-eye camera is used to sequentially shoot each left-eye video frame of a target spatial video, and the right-eye camera is used to sequentially shoot each right-eye video frame of a target spatial video.

In S102, encoding processing is performed on the first-eye video frame and the second-eye video frame to obtain media data of target spatial video.

The target spatial video can be understood as a spatial video currently to be generated, in other words, a spatial video currently shot. The type of target spatial video is not limited, and for example, target spatial video may be MV-HEVC spatial video. MV-HEVC spatial video is a three-dimensional video realized by using the MV-HEVC spatial video encode format. It can simulate the stereo vision of the human eye, allowing the audience to clearly feel the depth and distance of the video, thereby providing an immersive viewing experience. MV-HEVC allows multiple image information to be included in the same video frame data. For example, each piece of video frame data of MV-HEVC spatial video may include image information of the left eye (such as left-eye video frame data) and image information of the right eye (such as right-eye video frame data). Different from the traditional side-by-side display mode, MV-HEVC stores the difference information between the main view and the auxiliary view, so that it may also be played as normal HEVC video on devices that do not support three-dimensional viewing.

For example, encoding processing may be performed on the first-eye video frame and the second-eye video frame. For example, encoding processing may be performed on the first-eye video frame and the second-eye video frame according to the shooting sequence of video frame (including the first-eye video frame and the second-eye video frame). Specifically, encoding processing may be performed simultaneously on the first-eye video frame and the second-eye video frame having timestamps that match with each other. Encoding processing may also be performed successively. For example, encoding processing for the first-eye video frame and the second-eye video frame having timestamps that match with each other may be performed in adjacent order. The specific method for performing encoding processing one the first-eye video frame and the second-eye video frame are not limited in the present disclosure.

It can be understood that before performing encoding processing on the first-eye video frame and the second-eye video frame, rendering may be performed on the first-eye video frame and the second-eye video frame. For example, the first frame queue shot by the first camera and the second frame queue shot by the second camera may be alternately drawn onto the Surface created by the video encoder, and the first-eye video frame and the second-eye video frame obtained by rendering may be obtained through the Graphic Buffer Source. Surface may be an object pointing to graphics memory, which is used to draw image content to display image content on display screen, so as to achieve a smooth display effect. Graphic Buffer usually refers to an internal memory buffer, which contains image data that will be displayed on the screen, such as data queues.

In S103, a target video file of the target spatial video is generated according to the media data and the codec specific data of the target spatial video, where the codec specific data includes first-eye codec specific data and second-eye codec specific data.

Codec Specific Data (CSD) can be understood as data used to describe codec features, which may be a sequence parameter set of a series of metadata. Exemplarily, the codec specific data includes a first-eye codec specific data and a second-eye codec specific data. The first-eye codec specific data may be used to describe the codec feature of the first-eye video frame, and the second-eye codec specific data may be used to describe the codec feature of the second-eye video frame. When the first-eye video frame is left-eye video frame and the second-eye video frame is right-eye video frame, the first-eye codec specific data may be left-eye codec specific data, and the second-eye codec specific data may be right-eye codec specific data.

The codec specific data may be generated when performing encoding on video frame. For example, the first-eye codec specific data of the target spatial video may be determined and generated before, after, or when performing encoding processing on the first frame of the first-eye video frame of the target spatial video; and the second-eye codec specific data of the target spatial video may be determined and generated before, after, or when performing encoding processing on the first frame of the second-eye video frame of the target spatial video.

Exemplarily, the first-eye codec specific data may include a Video Parameter Set (VPS) for target spatial video, a Sequence Parameter Set (SPS) for the first-eye video frame, and a Picture Parameter Set (PPS) for the first-eye video frame. The second-eye codec specific data may include the Sequence Parameter set (SPS) for the second-eye video frame and a Picture Parameter Set (PPS) for the second-eye video frame. Since the first-eye video frame and the second-eye video frame may share the same video parameter set, when video parameter set is included in the first-eye codec specific data, the second-eye codec specific data may not include video parameter set, so as to reduce the storage space occupied by the codec specific data.

Video parameter set (VPS) may be used to transmit video classification information. For example, the video parameter set (VPS) may be used to describe the overall structure of encoded video sequence, including temporal sublayer dependency relationship, etc. Sequence parameter set (SPS) may be used to describe configuration information of a video sequence. For example, a set of global parameters of a coded video sequence may be stored in the sequence parameter set, and the global parameters may include encode level and/or resolution, etc. The coded video sequence can be understood as a sequence composed of the video frames of the original video after being encoded. The picture parameter set may be used to describe the encode parameters of video frame, and the encode parameters may be understood as parameters related to image processing and encoding, such as image size, frame rate, and/or color space, etc.

The target video file may be understood as a video file of a target spatial video, and by way of example, the target video file may be a Moving Picture Experts Group 4 (MP4) file.

Specifically, the target video file of the target spatial video may be generated based on the media data of the target spatial video and the codec specific data of the target spatial video.

Taking MP4 file as an example of the target video file, after encoding processing is performed on each video frame, the video frame data (including the first-eye video frame data and the second-eye video frame data) obtained by encoding each video frame may be stored in real time in the media data Chunk of the target video file, and the codec specific data (including the first-eye codec specific data and the second-eye codec specific data) of the target video may be stored into a metadata block (MOOV) of the target video file, thereby encapsulating to obtain the target video file of the target video.

The method of generating a spatial video according to the present embodiment includes: shooting a first frame queue by a first camera, and shooting a second frame queue by a second camera, where the first frame queue includes at least one first-eye video frame, and the second frame queue includes at least one second-eye video frame; performing encoding processing on the first-eye video frame and the second-eye video frame to obtain the media data of target spatial video; generating a target video file of the target spatial video according to the media data and codec specific data of the target spatial video, where the codec specific data includes first-eye codec specific data and second-eye codec specific data. In this embodiment, when the spatial video is generated, the first-eye codec specific data and the second-eye codec specific data of the spatial video are respectively stored in the video file of the target spatial video, the first-eye codec specific data indicates the codec feature of the first-eye video frame of the spatial video, and the second-eye codec specific data indicates the codec feature of the second-eye video frame of the spatial video, thereby realizing the generation of the spatial video in the Android system and enriching the generation method of the spatial video.

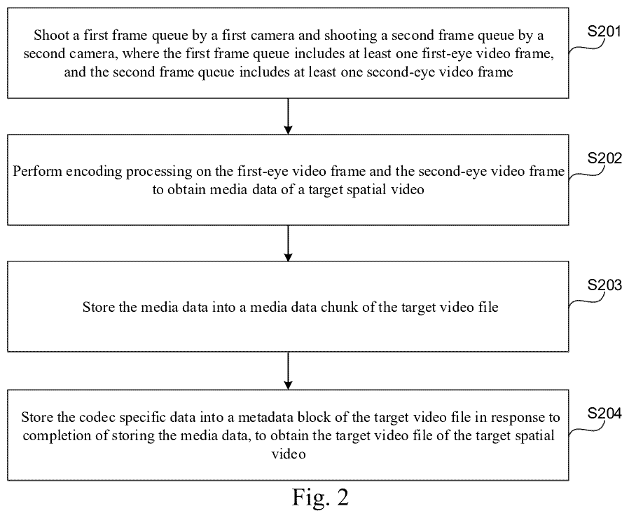

FIG. 2 is a schematic flowchart of another method of generating a spatial video according to an embodiment of the present disclosure. The schemes in this embodiment may be combined with one or more of the alternatives in the above embodiments. Optionally, the generating a target video file of the target spatial video according to the media data and codec specific data of the target spatial video includes: storing the media data into a media data chunk of the target video file; and storing the codec specific data into a metadata block of the target video file in response to completion of storing the media data, to obtain the target video file of the target spatial video.

Accordingly, as shown in FIG. 2, the method of generating a spatial video according to the present embodiment may include:

In S201, shooting a first frame queue by a first camera, and shooting a second frame queue by a second camera, where the first frame queue includes at least one first-eye video frame, and the second frame queue includes at least one second-eye video frame.

In S202, performing encoding processing on the first-eye video frame and the second-eye video frame to obtain the media data of target spatial video.

In S203, storing the media data into a media data chunk of the target video file.

In this embodiment, after obtaining the media data of target spatial video by encoding, the media data of target spatial video may be stored in the media data chunk of the target video file.

For example, the media data of the target spatial video may be stored in the media data chunk of the target video file in real time. For example, encoding processing may be performed on the video frame of the target spatial video obtained by shooting during the shooting process, and after obtaining video frame data of a certain frame of the target spatial video by encoding, the video frame data is written into Chunk of the target video file. The video frame data of a certain frame of the target spatial video may include first-eye video frame data and second-eye video frame data corresponding to the timestamp of the video frame data.

In S204, storing the codec specific data into a metadata block of the target video file in response to completion of storing the media data, to obtain the target video file of the target spatial video.

Specifically, when the media data of the target video is stored, the codec specific data of the target video may be stored in the metadata block of the target video file. For example, the metadata block of the target video file may be nested with the configuration information data chunk HVC1, and the codec specific data of the target video file may be stored in the HVC1 of the target video file.

In the present embodiment, the codec specific data of the target spatial video may include the first-eye codec specific data and the second-eye codec specific data of the target spatial video.

Taking the storing of the codec specific data of the target spatial video in the HVC 1 of the target video file as an example, the first-eye codec specific data and the second-eye codec specific data of the target spatial video may be stored in the same or different sub-data chunk (Box) of the HVC 1.

In some examples, a first-eye identifier may be added to the first-eye codec specific data of the target spatial video, a second-eye identifier may be added to the second-eye codec specific data of the target spatial video, and the first-eye codec specific data after adding the first-eye identifier and the second-eye codec specific data after adding the second-eye identifier may be stored in the same sub-data chunk of the HVC1, such as in the hvcC box of the HVC1. After storing, the stored first-eye codec specific data and the stored second-eye codec specific data may be distinguished by the first-eye identifier and the second-eye identifier.

In other examples, the first-eye codec specific data and the second-eye codec specific data of the target spatial video may be stored in different sub-data chunk of the HVC 1, that is, in different configuration information sub-data chunk. At this time, optionally, the first-eye codec specific data and the second-eye codec specific data are stored in different configuration information sub-data chunk of the metadata block. For example, HVC1 may include an hvcC box, and evcC box may be customized in HVC1. Accordingly, the first-eye codec specific data of the target spatial video may be stored in the hvcC box of the HVC1, and the second-eye codec specific data of the target spatial video may be stored in the evcC box of the HVC1. After storing, the first-eye codec specific data and the second-eye codec specific data of the target spatial video may be distinguished by the difference of the stored sub-data chunk box. The customization mode of the evcC box is not limited, and for example, the parameters of the evcC box may be the same as those of the hvcC box except that the codec specific data used for storing is different.

In some embodiments, the media data includes continuous video frame data, and the performing encoding processing on the first-eye video frame and the second-eye video frame to obtain media data of a target spatial video includes: determining a first-eye video frame currently to be encoded in the first frame queue and a second-eye video frame currently to be encoded in the second frame queue, where a timestamp of the first-eye video frame currently to be encoded and a timestamp of the second-eye video frame currently to be encoded match with each other; and performing encoding processing on the first-eye video frame currently to be encoded to obtain a first-eye video frame data, and performing encoding processing on the second-eye video frame currently to be encoded to obtain a second-eye video frame data. The storing the media data into a media data chunk of the target video file includes: packaging the first-eye video frame data and the second-eye video frame data into current video frame data of the target spatial video, and storing the current video frame data into the media data chunk of the target video file.

In the above-described embodiment, the first-eye video frame and the second-eye video frame having timestamps that match with each other may be used as the left-eye video frame and the right-eye video frame to be displayed synchronously in the target spatial video, and encoding processing and storing may be performed together.

Timestamps matches each other may be understood as timestamps being closest. The first-eye video frame currently to be encoded can be understood as the first-eye video frame that currently needs to be encoded. The second-eye video frame currently to be encoded can be understood as the second-eye video frame that currently needs to be encoded. The first-eye video frame data may be video frame data obtained by performing encoding processing on the above-mentioned first-eye video frame currently to be encoded. The second-eye video frame data may be video frame data obtained by performing encoding processing on the above-mentioned second-eye video frame currently to be encoded. The current video frame data can be understood as video frame data after packaging the first-eye video frame data and the second-eye video frame data, that is, the packaged data of the first-eye video frame data and the second-eye video frame data.

For example, according to the arrangement order of each first-eye video frame in the first frame queue, encoding processing may be sequentially performed on the first-eye video frame and the second-eye video frame.

Specifically, according to the arrangement order of each first-eye video frame in the first frame queue, the first-eye video frame in the first frame queue that currently needs to be encoded may be determined as the first-eye video frame currently to be encoded, and the second-eye video frame whose timestamp is closest to the timestamp of the first-eye video frame currently to be encoded may be obtained from the second frame queue as the second-eye video frame currently to be encoded.

After that, encoding processing may be performed on the first-eye video frame currently to be encoded to obtain the first-eye video frame data, and encoding processing may be performed on the second-eye video frame currently to be encoded to obtain the second-eye video frame data. Encoding processing may be performed on the first-eye video frame and the second-eye video frame having timestamps that match with each other at the same time, or encoding processing may be performed first on one of the first-eye video frame and the second-eye video frame having timestamps that match with each other, and then on the other video frame, which can be flexibly set according to needs.

After obtaining the first-eye video frame data and the second-eye video frame data, the first-eye video frame data and the second-eye video frame data may be packaged as one frame of target space data of the target spatial video. That is, each frame of target space data of the target spatial video may include the first-eye video frame data and the second-eye video frame data. After the packaging is completed, the packaged video frame data may be stored as one frame of video frame data of target spatial video in the media data chunk of the target video file. Thereby, encoding and storing of media data of target spatial video can be realized.

In some embodiments, the first-eye video frame data and the second-eye video frame data in the video frame data may be distinguished by a packing order, for example, the first-eye video frame data and the second-eye video frame data may be packed in a preset packing order. Therefore, the first-eye video frame data and the second-eye video frame data in the video frame data of the target spatial video may be distinguished according to this packing order.

In some embodiments, the first-eye video frame may carry a first-eye identifier and the second-eye video frame may carry a second-eye identifier. Therefore, after the compilation of encoding and decoding and/or the packaging, the first-eye video frame data and the second-eye video frame data may be distinguished according to the carried identifier. At this time, optionally, before determining a first-eye video frame currently to be encoded in the first frame queue and a second-eye video frame currently to be encoded in the second frame queue, the method further, the method further includes: adding a first-eye identifier to the first-eye video frame in the first frame queue and adding a second-eye identifier to the second-eye video frame in the second frame queue. The first-eye identifier may be used to indicate that the corresponding data is data corresponding to the first eye, and the second-eye identifier may be used to indicate that the corresponding data is data corresponding to the second eye.

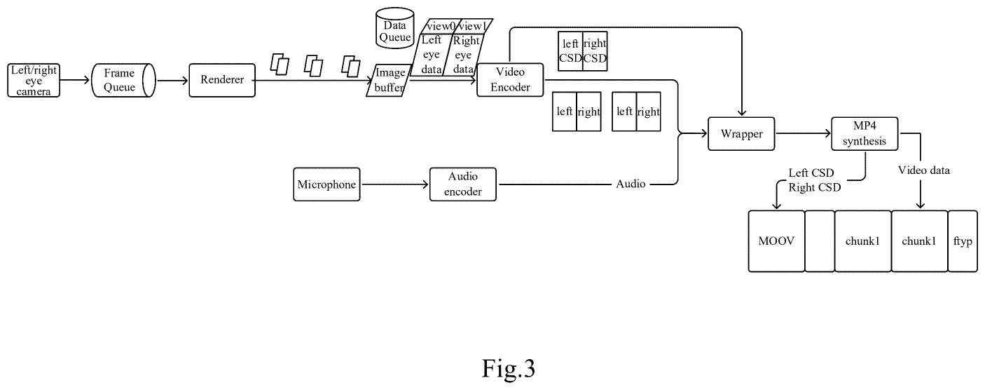

FIG. 3 is a schematic diagram of a process of generating a spatial video according to an embodiment of the present disclosure. In some alternative embodiments, as shown in FIG. 3, the generation process of spatial video may be described as:

A1. After detecting that the user executes the recording operation, for example, after detecting that the user triggers the recording control, the binocular camera is controlled to shoot, and the left-eye frame queue shot by the left-eye camera of the binocular camera and the right-eye frame queue shot by the right-eye camera of the binocular camera are obtained.

A2. Use the renderer to alternately draw the image frame of the left-eye frame queue and the right-eye frame queue on the Surface created by video encoder (Codec), and use the Graphic Buffer Source to obtain the left-eye and right-eye video frame (Frame) obtained by rendering, that is, obtain the left-eye frame and right-eye frame obtained by rendering.

A3. Add eye identifier to the left-eye frame and the right-eye frame. For example, add left-eye identifier view-id: 0 to the left-eye frame and add right-eye identifier view-id: 1 to the right-eye frame.

A4. Store the left-eye frame and the right-eye frame into an encode working example C2Work and transmit it to the video encoder android codec2 for encoding.

A5. After being encoded by the video encoder, the encoded left-eye video frame data (i.e. left-eye video data) and right-eye video frame data (i.e. right-eye video data) and codec specific data CSD is output. The left-eye CSD includes VPS, SPS and PPS, and the right-eye CSD includes SPS and PPS. At this time, the left-eye CSD and the right-eye CSD may be transmitted to the Wrapper MediaMuxer, respectively, and the left-eye video data and the right-eye video data having timestamps that match with each other are packaged and transmit to the MediaMuxer together.

For example, when the video encoder performs encoding on the first frame of the left-eye frame and the first frame of the right-eye frame, the video encoder may output the first frame left eye encode data, the first frame right-eye video frame data, and the CSD obtained by encoding. When encoding is performed on the left-eye frame and the right-eye frame other than the first frame of the left-eye frame and the first frame of the right-eye frame, the left-eye video frame data and the right-eye video frame data obtained by encoding may be output, and at this time, there is no need to output CSD.

Accordingly, after receiving the first frame left-eye video data, the first frame right-eye video data, and the CSD output by the video encoder, the current application may split to obtain the first frame video data and the CSD, and first send the CSD to the MediaMuxer, and then send the first frame video data to the MediaMuxer. When the current application receives other video data outputted by the video encoder except the first frame video data, it may send it to the MediaMuxer.

A6. After receiving the left-eye CSD and the right-eye CSD, MediaMuxer packages and stores the two CSDs into the hvcC box and the customized evcC box in hvc1 of the MP4 file respectively, and writes the received video data into the chunk of the MP4 file.

Specifically, the hvc1 of the MP4 file may include an hvcC box and a customized evcC box. After receiving the CSD, MediaMuxer may store it into the cache; MediaMuxer, after receiving the video data, may write it into the chunk of the MP4 file in real time. After all video data is stored, the left-eye CSD may be written into the hvcC box in hvc1, and the right-eye CSD data may be written into the customized evcC box.

In addition, as shown in FIG. 3, the audio data collected by the microphone will also be sent to MediaMuxer after being encoded by the audio encoder, and will be stored in an MP4 file by MediaMuxer.

It can be seen that in the above embodiment, when encoding is performed, the left-eye data and the right-eye data having timestamps that match with each other may be continuously read from the GraphicBuffer Source, and send together to video encoder for encoding. The video encoder will first output the configuration data CSD data of video. Because it is MV-HEVC, it will include two sets of CSDs, namely the left-eye CSD and the right-eye CSD. After two sets of CSDs are transmitted to MediaMuxer, the left-eye CSD is written into hvcC box, and the right-eye CSD is written into the customized evcC box. The left-eye video data and right-eye video data output by encode and having timestamps that match with each other will be packaged together and transmitted to mediaMuxer for storing.

The method of generating the spatial video according to the present embodiment can realize the generation of the spatial video in the Android system, and enrich the generation method of the spatial video.

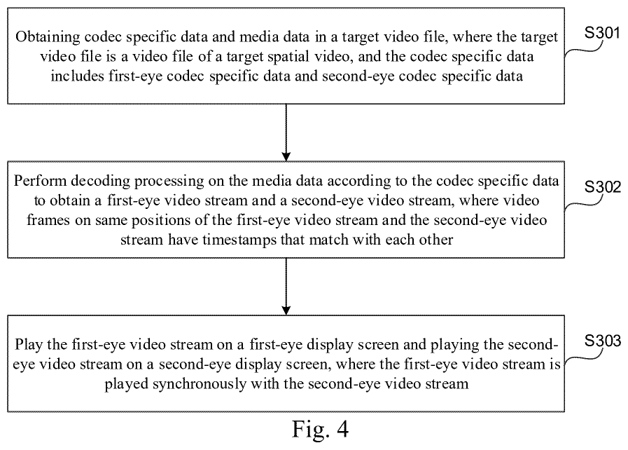

FIG. 4 is a schematic flowchart of a method of playing a spatial video according to an embodiment of the present disclosure. The method may be performed by a playing apparatus for spatial video, where the apparatus may be implemented by software and/or hardware, configured in an electronic device, typically in a VR device. The method of playing a spatial video according to an embodiment of the present disclosure is applicable to a scene in which a spatial video is played, for example, a scene in which VR device having an Android system as the operating system is used to play a spatial video. As shown in FIG. 4, the method of playing a spatial video according to the present embodiment may include:

In S301: obtaining codec specific data and media data in a target video file, where the target video file is a video file of a target spatial video, and the codec specific data includes first-eye codec specific data and second-eye codec specific data.

Specifically, when the playing operation for the target spatial video is received, the target video file of the target spatial video may be obtained; performing parsing on the target video file to obtain codec specific data of the target spatial video, and obtain the media data of the target spatial video from the target spatial video.

In some embodiments, the codec specific data of the target spatial video may be stored in the metadata block of the target video file, and the media data of the target spatial video may be stored in the media data chunk of the target video file. Thus, the codec specific data of the target spatial video may be obtained by parsing from the metadata block of the target video file, and the media data of the target spatial video may be obtained by parsing from the media data chunk of the target video file. At this time, optionally, obtaining codec specific data and media data in a target video file includes: performing parsing on the metadata block of the target video file to obtain codec specific data of the target spatial video; and performing parsing on the media data chunk of the target video file to obtain the media data of the target spatial video.

In some embodiments, the codec specific data of the target spatial video may include first-eye codec specific data (e.g., left-eye codec specific data) and second-eye codec specific data (e.g., right-eye codec specific data). The first-eye codec specific data and the second-eye codec specific data of the target spatial video may be stored in the configuration information data chunk HVC 1 in which the metadata is nested, for example, the first-eye codec specific data and the second-eye codec specific data of the target spatial video may be stored in the same or different sub-data chunk of the HVC1.

Optionally, the obtaining the codec specific data of the target spatial video includes: obtaining the first-eye codec specific data of the target spatial video from the first configuration information sub-data chunk of the metadata block; and obtaining second-eye codec specific data of the target spatial video from the second configuration information sub-data chunk of the metadata block.

Here, the first configuration information sub-data chunk may be understood as a sub-data chunk for storing the first-eye codec specific data, such as a sub-data chunk for storing the first-eye codec specific data in the HVC 1. The second configuration information sub-data chunk may be understood as a sub-data chunk for storing the second-eye codec specific data, such as a sub-data chunk for storing the second-eye codec specific data in the HVC1. For example, the first configuration information sub-data chunk may be an hvcC box in the HVC1, and the second configuration information sub-data chunk may be an evcC box customized in the HVC1.

Exemplarily, a first-eye codec specific data of the target spatial video may be stored in the first configuration information sub-data chunk, and a second-eye codec specific data of the target spatial video may be stored in a second configuration information sub-data chunk. Accordingly, it is possible to obtain the first-eye codec specific data of the target spatial video from the first configuration information sub-data chunk, and to obtain the second-eye codec specific data of the target spatial video from the second configuration information sub-data chunk. In other words, the codec specific data stored in the first configuration information sub-data chunk may be determined as the first-eye codec specific data of the target spatial video, and the codec specific data stored in the second configuration information sub-data chunk may be determined as the second-eye codec specific data of the target spatial video.

In S302, performing decoding processing on the media data according to the codec specific data to obtain a first-eye video stream and a second-eye video stream, and video frames on same positions of the first-eye video stream and the second-eye video stream have timestamps that match with each other.

Specifically, after obtaining the codec specific data of the target spatial video, decoding processing may be performed on the media data of the target spatial video according to the codec specific data of the target spatial video, and rendering may be sequentially performed on each piece of the first-eye video frame data that is decoded, by using the render, to obtain the first-eye video stream of the target space, and rendering may be sequentially performed on each piece of the second-eye video frame data that is decoded, by using the render, to obtain the second-eye video stream of the target space.

In some embodiments, the codec specific data of the target spatial video may be obtained first by parsing, and decoder (such as video decoder) may be configured according to the codec specific data. For example, corresponding parameters of decoder may be configured. After the configuration is completed, the media data of target spatial video may be parsed, and the configured decoder may be used to perform parsing processing on the media data of the target spatial video. After the decoding processing is completed, the first-eye video stream and the second-eye video stream of the target spatial video may be obtained by rendering. At this time, optionally, performing decoding processing on the media data according to the codec specific data to obtain a first-eye video stream and a second-eye video stream includes: configuring a decode according to the codec specific data; and after the configuring is completed, performing decoding processing on the media data through the decoder to obtain a first-eye video stream and a second-eye video stream.

In some embodiments, the media data includes continuous video frame data, and performing decoding processing on the media data by the decoder to obtain a first-eye video stream and a second-eye video stream, including: obtaining video frame data currently to be decoded according to an arrangement order of the video frame data; splitting the video frame data currently to be decoded to obtain the first-eye video frame data currently to be decoded and the second-eye video frame data currently to be decoded; performing decoding processing on the first-eye video frame data currently to be decoded by the decoder to obtain one first-eye video frame in the first-eye video frame, and performing decoding processing on the second-eye video frame data currently to be decoded by the decode to obtain one second-eye video frame in the second-eye video frame.

The video frame data currently to be decoded can be understood as the video frame data currently needs to be decoded, which may be the video frame data that has not been decoded and has the earliest timestamp.

In the above embodiment, the media data of the target spatial video may include continuous video frame data of the target spatial video, and each piece of video frame data includes the first-eye video frame data and the second-eye video frame data, that is, the video frame data of the first-eye video frame and the second-eye video frame of the target spatial video having timestamps that match with each other may be packaged and stored in the target video file of the target spatial video.

When performing decoding, for example, the video frame data currently to be decoded can be determined according to the arrangement order of each piece of video frame data.

After determining the video frame data currently to be decoded, the video frame data currently to be decoded may be split to obtain the first-eye video frame data currently to be decoded and the second-eye video frame data currently to be decoded. For example, the first-eye video frame data may carry the first-eye identifier, and the second-eye video frame data may carry the second-eye identifier, so that the first-eye video frame data in which the first-eye identifier is carried in the video frame data currently to be decode may be obtained, and the second-eye video frame data in which the second-eye identifier is carried in the video frame data currently to be decode may be obtained.

After obtaining the first-eye video frame data currently to be decoded and the second-eye video frame data currently to be decoded, the first-eye video frame data currently to be decoded may be decoded by decoder and rendered to obtain the first-eye video frame; and the second-eye video frame data currently to be decoded may be decoded by decoder and rendered to obtain the second-eye video frame. The decoder may perform decoding processing on the first-eye video frame data based on the first-eye codec specific data, and may perform decoding processing on the second-eye video frame based on the second-eye codec specific data.

Therefore, with the continuous decoding of decoder and the continuous rendering of render, the first-eye video stream and the second-eye video stream of the target spatial video may be obtained.

S303: playing the first-eye video stream on a first-eye display screen and playing the second-eye video stream on a second-eye display screen, where the first-eye video stream is played synchronously with the second-eye video stream.

The VR device may be equipped with at least two display screens, i.e., the first-eye display screen and the second-eye display screen. The first-eye display screen can be understood as the display screen used to play the first-eye video stream on the VR device, and the second-eye display screen can be understood as the display screen used to play the second-eye video stream on the VR device.

In the present embodiment, when playing the target spatial video, the first-eye video stream of that target spatial video may be played on a first-eye display screen and a second-eye video stream of the target spatial video may be played on a second-eye display screen synchronously. Taking the first-eye video stream as the left-eye video stream and the second-eye video stream as the right-eye of video stream as an example, The left-eye video frame of the target spatial video may be sequentially displayed on the left-eye display screen (i. e. the first-eye display screen) and the right-eye video frame of the target spatial video may be sequentially displayed on the right-eye display screen (i. e. the second-eye display screen), so that the target spatial video may be played. The left-eye video frame and right-eye video frame having timestamps that match with each other are displayed synchronously.

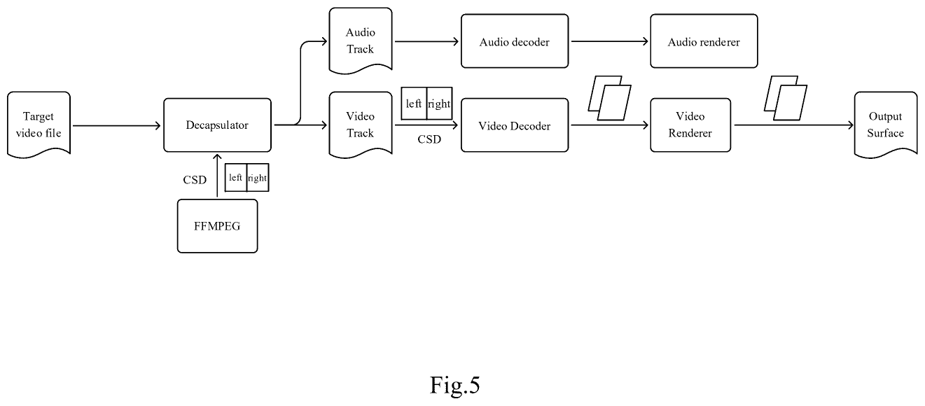

FIG. 5 is a schematic diagram of a process of playing a spatial video according to an embodiment of the present disclosure. In some alternative embodiments, as shown in FIG. 5, the process of playing the spatial video may be described as:

B1. Use the parser ffmpeg as the decapsulator, and parse the MP4 file of the video through the parser ffmpeg. If it is parsed to the evcC box, it means that the video is an MV-HEVC spatial video. Add left-eye identifier to the parsed hvcc (i.e. left-eye CSD), add right-eye identifier to the parsed evcC (i.e. right-eye CSD), package it into CSD and transmit it to the video decoder decoder.

B2. After receiving the CSD of the spatial video, the video decoder may split the CSD into a left-eye CSD and a right-eye CSD according to the left-eye identifier and the right-eye identifier, and perform decoding configuration according to the left-eye CSD and the right-eye CSD.

B3. After the video decoding configuration is completed, the video data of the spatial video may be read through ffmpeg.

B4. After reading the video data of the spatial video, the read video data may be split to obtain the left-eye video data and the right-eye video data, and the left-eye video data and the right-eye video data obtained by splitting may be put into c2work and sent to video decoder for decoding. Accordingly, the video decoder may distinguish the received left-eye video data and the right-eye video data according to the left-eye identifier view-id: 0 and the right-eye identifier view-id: 1, and perform decoding processing on the left-eye video data according to the left-eye CSD, and perform decoding processing on the right-eye video data according to the right-eye CSD.

B5. After the video decoder performs decoding on the left-eye video data and the right-eye video data, the video renderer may perform rendering based on the decoded data to obtain the left-eye frame and the right-eye frame. For example, the decoded left-eye video data and the decoded right-eye video data are output to the Surface, and the left-eye frame and right-eye frame may be obtained when display module runs, and displayed on the corresponding display screen.

In addition, as shown in FIG. 5, while performing decoding and rendering on video frame data, audio decoder will also perform decoding processing on the audio data of the target spatial video, and the decoded audio data may be sent to audio renderer for rendering and playback.

It can be seen that in the above embodiment, when decoding, MP4 files may be parsed through ffmpeg, and when parsing hvc1 box, if it is parsed to evcC box, hvcC data and evcC data will be sent to the decoding module together, and the decoding module will read and split VPS, SPS, and PPS (i.e. left-eye CSD) of left-eye data and SPS and PPS (i.e. right-eye CSD) of right-eye data, and then send them to Video decoder for configuration (config). When reading video data, ffmpeg reads a sample sample (including left-eye and right-eye data), and video decoder will split the eft-eye and right-eye data into two parts, and then send them to video decoder for decoding.

The method of playing a spatial video according to the present embodiment includes obtaining codec specific data and media data in a target video file, where the target video file is a video file of a target spatial video, and the codec specific data includes a first-eye codec specific data and a second-eye codec specific data; performing decoding processing on the media data according to the codec specific data to obtain a first-eye video stream and a second-eye video stream, where video frames on same positions of the first-eye video stream and the second-eye video stream have timestamps that match with each other; playing the first-eye video stream on a first-eye display screen and playing the second-eye video stream on a second-eye display screen, where the first-eye video stream is played synchronously with the second-eye video stream. According to the above technical solution, in the present embodiment, when playing the spatial video, decoding is performed on the media data in the video file based on the first-eye codec specific data and the second-eye codec specific data in the video file of the spatial video, so that the playback of the spatial video can be realized in the Android system, and the playback mode of the spatial video can be enriched.

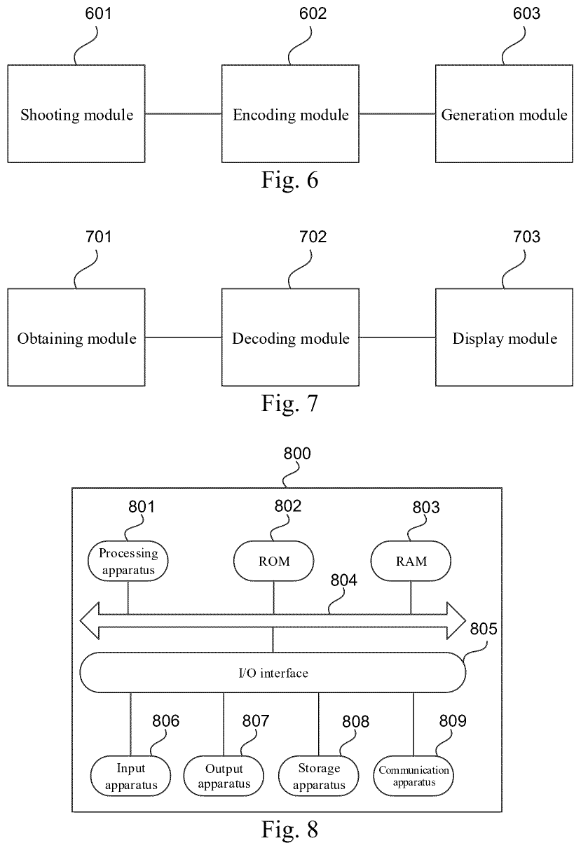

FIG. 6 is a structural block diagram of an apparatus for generating a spatial video according to an embodiment of the present disclosure. The apparatus may be implemented by software and/or hardware, may be configured in an electronic device, typically, may be configured in a Virtual Reality (VR) device, a mobile phone or a tablet computer, and may shoot a spatial video by performing a method of generating a spatial video, such as shooting a spatial video using electronic device with an Android operating system. As shown in FIG. 6, the apparatus for generating a spatial video according to the present embodiment may include a shooting module 601, an encoding module 602, and a generation module 603.

The shooting module 601 is configured to shoot a first frame queue by a first camera and shoot a second frame queue by a second camera, where the first frame queue includes at least one first-eye video frame, and the second frame queue includes at least one second-eye video frame;

The encoding module 602 is configured to perform encoding processing on the first-eye video frame and the second-eye video frame to obtain media data of target spatial video;

The generation module 603 is configured to generate a target video file of the target spatial video according to the media data and the codec specific data of the target spatial video, where the codec specific data includes a first-eye codec specific data and a second-eye codec specific data.

In the apparatus for generating the spatial video according to the present embodiment, the shooting module 601 is configured to shoot a first frame queue by a first camera and shoot a second frame queue by a second camera, where the first frame queue includes at least one first-eye video frame, and the second frame queue includes at least one second-eye video frame; the encoding module is configured to perform encoding processing on the first-eye video frame and the second-eye video frame to obtain media data of target spatial video; and the generation module is configured to generate a target video file of the target spatial video according to the media data and the codec specific data of the target spatial video, where the codec specific data includes a first-eye codec specific data and a second-eye codec specific data. In this embodiment, when the spatial video is generated, the first-eye codec specific data and the second-eye codec specific data of the spatial video are respectively stored in the video file of the target spatial video, the first-eye codec specific data indicates the codec feature of the first-eye video frame of the spatial video, and the second-eye codec specific data indicates the codec feature of the second-eye video frame of the spatial video, thereby realizing the generation of the spatial video in the Android system and enriching the generation method of the spatial video.

Optionally, the generation module 603 includes: a media data storing unit configured to store the media data in a media data chunk of the target video file; A specific data storing unit, configured to store the codec specific data into a metadata block of the target video file in response to the completion of storing the media data to obtain a target video file of the target spatial video.

Optionally, the first-eye codec specific data and the second-eye codec specific data are stored in different configuration information sub-data chunk of the metadata block.

Optionally, the media data includes continuous video frame data, and the encoding module 602 includes: video frame determination unit, configured to determine a first-eye video frame currently to be encoded in the first frame queue and a second-eye video frame currently to be encoded in the second frame queue, where first-eye video frame currently to be encoded and the second-eye video frame currently to be encoded have timestamps that match with each other; an encoding unit configured to perform encoding processing on the first-eye video frame currently to be encoded to obtain first-eye video frame data, and perform encoding processing on the second-eye video frame currently to be encoded to obtain second-eye video frame data; a media data storing unit, specifically configured to package the first-eye video frame data and the second-eye video frame data into current video frame data of the target spatial video, and store the current video frame data into a media data chunk of the target video file.

Further, the apparatus for generating the spatial video may further include: an identifier adding module configured to add a first-eye identifier to the first encode in the first frame queue and add a second-eye identifier to the second-eye video frame in the second frame queue before determining the first-eye video frame currently to be encoded in the first frame queue and the second-eye video frame currently to be encoded in the second frame queue.

The apparatus for generating the spatial video according to the embodiment of the present disclosure may execute the method of generating the spatial video according to any embodiment of the present disclosure, and has functional modules and beneficial effects corresponding to the execution of the spatial video generation method. For technical details not described in detail in this embodiment, see the method of generating a spatial video provided by any embodiment of the present disclosure.

FIG. 7 is a structural block diagram of an apparatus for playing a spatial video according to an embodiment of the present disclosure. The apparatus may be implemented by software and/or hardware, may be configured in an electronic device, typically, may be configured in a VR device, and may play a spatial video by performing a method of playing a spatial video, such as playing a spatial video by a VR device with Android system as operating system. As shown in FIG. 7, the apparatus for playing the spatial video provided by the present embodiment may include: obtaining module 701, decoding module 702, and display module 703.

The obtaining module 701 is configured to obtain codec specific data and media data in a target video file, where the target video file is a video file of a target spatial video, and the codec specific data includes first-eye codec specific data and second-eye codec specific data;

The decoding module 702 is configured to perform decoding processing on the media data according to the codec specific data to obtain a first-eye video stream and a second-eye video stream, where video frames on same positions of the first-eye video stream and the second-eye video stream have timestamps that match with each other;

The display module 703 is configured to play the first-eye video stream on a first-eye display screen and play the second-eye video stream on a second-eye display screen, where the first-eye video stream is played synchronously with the second-eye video stream.

In the spatial video playback apparatus according to the present embodiment, the obtaining module is configured to obtain codec specific data and media data in a target video file, where the target video file is a video file of a target spatial video, and the codec specific data includes first-eye codec specific data and second-eye codec specific data; the decoding module is configured to perform decoding processing on the media data according to the codec specific data to obtain a first-eye video stream and a second-eye video stream, where video frames on same positions of the first-eye video stream and the second-eye video stream have timestamps that match with each other; and the display module is configured to play the first-eye video stream on a first-eye display screen and play the second-eye video stream on a second-eye display screen, where the first-eye video stream is played synchronously with the second-eye video stream. According to the above technical solution, in the present embodiment, when playing the spatial video, decoding is performed on the media data in the video file based on the first-eye codec specific data and the second-eye codec specific data in the video file of the spatial video, so that the playback of the spatial video can be realized in the Android system, and the playback mode of the spatial video can be enriched.

Optionally, the obtaining module 701 includes: a specific data obtaining unit configured to perform parsing on the metadata block of the target video file to obtain codec specific data of the target spatial video; and a media data obtaining unit configured to perform parsing on the media data chunk of the target video file to obtain the media data of the target spatial video.

Optionally, the specific data obtaining unit is specifically configured to: obtain a first-eye codec specific data of the target spatial video from a first configuration information sub-data chunk of the metadata block; and obtaining a second-eye codec specific data of the target spatial video from a second configuration information sub-data chunk of the metadata block.

Optionally, the decoding module 702 includes: a decoder configuration unit configured to configure a decoder according to the codec specific data; and a decoding unit configured to perform decoding processing on the media data through the decoder to obtain a first-eye video stream and a second-eye video stream after the completion of the configuring.

Optionally, the decoding unit is specifically configured to: obtain video frame data currently to be decoded according to an arrangement order of the video frame data; split the video frame data currently to be decoded to obtain the first-eye video frame data currently to be decoded and the second-eye video frame data currently to be decoded; and perform decoding processing on the first-eye video frame data currently to be decoded by the decoder to obtain one first-eye video frame in the first-eye video frame, and perform decoding processing on the second-eye video frame data currently to be decoded by the decode to obtain one second-eye video frame in the second-eye video frame.

The apparatus for playing the spatial video according to the embodiment of the present disclosure may execute the method of playing the spatial video according to any embodiment of the present disclosure, and has functional modules and beneficial effects corresponding to the execution of the method of playing the spatial video. For technical details not described in detail in this embodiment, please refer to the method of playing the spatial video provided by any embodiment of the present disclosure.

Referring to FIG. 8 below shows a schematic structural diagram of an electronic device (e.g., terminal device) 800 suitable for use in implementing embodiments of the present disclosure. The terminal device in the embodiment of the present disclosure may include, but is not limited to, a mobile terminal such as a mobile phone, a notebook computer, a digital broadcast receiver, a PDA (personal digital assistant), a PAD (Tablet PC), a PMP (Portable Multimedia Player), an in-vehicle terminal (for example, an in-vehicle navigation terminal), and the like, and a fixed terminal such as a digital TV, a desktop computer, and the like. The electronic device illustrated in FIG. 8 is merely an example, and should not impose any limitation on the functionality and scope of use of the embodiments of the present disclosure.

As shown in FIG. 8, the electronic device 800 may include a processing apparatus (e.g., central processing unit, graphics processing unit, etc.) 801 that may perform various appropriate actions and processes according to a program stored in the read-only memory (ROM) 802 or a program loaded from the storage apparatus 808 into the random access memory (RAM) 803. In the RAM 803, various programs and data necessary for the operation of the electronic device 800 are also stored. The processing apparatus 801, the ROM 802, and the RAM 803 are connected to each other by a bus 804. An input/output (I/O) interface 805 is also connected to the bus 804.

Generally, the following devices may be connected to the I/O interface 805: touchpad 806 including, for example, touchscreen, accelerometer, a keyboard, a mouse, a camera, a microphone, gyroscope, input apparatus, etc.; A output apparatus 807 including, for example, a liquid crystal display (LCD), a speaker, a vibrator, and the like; Storage apparatus 808 including, for example, magnetic tape, hard disk, etc.; And communication apparatus 809. The communication apparatus 809 may allow the electronic device 800 to communicate wirelessly or wired with other devices to exchange data. Although FIG. 8 shows an electronic device 800 with various devices, it should be understood that it is not required that all of the devices shown be implemented or provided. More or fewer devices may alternatively be implemented or provided.

In particular, according to embodiments of the present disclosure, the process described above in the referring to flowchart may be implemented as a computer software program. For example, embodiments of the present disclosure include a computer program product including a computer program carried on a non-transitory computer-readable medium that contains program code for executing the method shown in the flowchart. In such embodiments, the computer program may be downloaded and installed from the network via communication apparatus 809, or installed from storage apparatus 808, or installed from ROM 802. When the computer program is executed by the processing apparatus 801, the above-described functions defined in the method of the embodiment of the present disclosure are executed.

The computer-readable medium of the present disclosure may be a computer-readable signal medium, a computer-readable storage medium, or any combination thereof. The computer-readable storage medium may be, for example, but is not limited to, an electrical, magnetic, optical, electromagnetic, infrared, or semiconductor system, apparatus, or device, or a combination of any of the above. More specific examples of computer-readable storage medium may include, but are not limited to, electrical connections with one or more wires, portable computer magnetic disk, hard disk, random access memory (RAM), read-only memory (ROM), erasable programmable read-only memory (EPROM or Flash), optical fiber, portable compact disc read-only memory (CD-ROM), optical storage device, magnetic storage device, or any suitable combination of the foregoing. In the present disclosure, computer-readable storage medium may be any tangible medium containing or storing a program that may be used by or in conjunction with an instruction execution system, apparatus, or device. Whereas in the present disclosure, a computer-readable signal medium may include a data signal propagated in a baseband or as part of a carrier wave, carrying computer-readable program code therein. Such propagated data signals may take a variety of forms, including, but not limited to, electromagnetic signals, optical signals, or any suitable combination of the foregoing. The computer-readable signal medium may also be any computer-readable medium other than the computer-readable storage medium that may transmit, propagate, or transmit a program for use by or in connection with an instruction execution system, apparatus, or device. The program code contained on the computer-readable medium may be transmitted using any suitable medium, including, but not limited to, wires, optical cables, RF (radio frequency), or the like, or any suitable combination of the foregoing.

In some embodiments, the client, server may communicate using any currently known or future developed network protocol such as HTTP (HyperText Transfer Protocol), and may be interconnected with any form or medium of digital data communication (e.g., a communication network). Examples of communication networks include local area networks (“LAN”), wide area networks (“WAN”), the Internet (e.g., the Internet), and end-to-end networks (e.g., ad hoc end-to-end networks), as well as any currently known or future-developed networks.

The computer-readable medium may be included in the electronic device described above; It may also exist alone without being fitted into the electronic device.

The computer-readable medium carries one or more programs that, when executed by the electronic device, cause the electronic device to: shoot a first frame queue by a first camera and shoot a second frame queue by a second camera, where the first frame queue includes at least one first-eye video frame, and the second frame queue includes at least one second-eye video frame; perform encoding processing on the first-eye video frame and the second-eye video frame to obtain media data of a target spatial video; and generate a target video file of the target spatial video according to the media data and codec specific data of the target spatial video, where the codec specific data includes first-eye codec specific data and second-eye codec specific data. Or
obtain codec specific data and media data in a target video file, where the target video file is a video file of a target spatial video, and the codec specific data includes first-eye codec specific data and second-eye codec specific data; perform decoding processing on the media data according to the codec specific data to obtain a first-eye video stream and a second-eye video stream, where video frames on same positions of the first-eye video stream and the second-eye video stream have timestamps that match with each other; and play the first-eye video stream on a first-eye display screen and playing the second-eye video stream on a second-eye display screen, where the first-eye video stream is played synchronously with the second-eye video stream.

Computer program code for performing the operations of the present disclosure may be written in one or more programming languages, or combinations thereof, including, but not limited to, object-oriented programming languages such as Java, Smalltalk, C++, but also conventional procedural programming languages such as the “C” language or similar programming languages. The program code may be executed entirely on the user's computer, partially on the user's computer, as a standalone software package, partially on the user's computer and partially on a remote computer, or entirely on a remote computer or server. In cases involving a remote computer, the remote computer may be connected to the user computer through any kind of network, including a local area network (LAN) or a wide area network (WAN), or may be connected to an external computer (e.g., using an Internet service provider to connect over the Internet).

Flowcharts and block diagrams in the drawings illustrate the architecture, functionality, and operation of possible implementations of systems, methods, and computer program product in accordance with various embodiments of the present disclosure. In this regard, each block in the flowchart or block diagram may represent a module, program segment, or portion of code that contains one or more executable instructions for implementing a specified logical function. It should also be noted that, in some alternative implementations, the functions noted in the blocks may also occur in a different order than that noted in the figures. For example, two blocks represented in succession may actually be executed substantially in parallel, and they may sometimes be executed in reverse order, depending on the function involved. It is also noted that each block in the block diagrams and/or flowchart diagrams, and combinations of blocks in the block diagrams and/or flowchart diagrams, may be implemented with a dedicated hardware-based system that performs the specified functions or operations, or may be implemented with a combination of dedicated hardware and computer instructions.

The units described in the embodiments of the present disclosure may be implemented by software or hardware. The name of the module does not constitute a limitation of the unit itself in some cases.

The functions described above herein may be performed, at least in part, by one or more hardware logic components. For example, and without limitation, exemplary types of hardware logic components that may be used include Field Programmable Gate Arrays (FPGAs), Application Specific Integrated Circuits (ASICs), Application Specific Standard Products (ASSPs), Systems on tile (SOCs), Complex Programmable Logic Devices (CPLDs), and the like.

In the context of the present disclosure, the machine-readable medium may be a tangible medium that may contain or store a program for use by or in conjunction with an instruction execution system, apparatus, or device. The machine readable medium may be a machine readable signal medium or a machine readable storage medium. The machine-readable medium may include, but is not limited to, electronic, magnetic, optical, electromagnetic, infrared, or semiconductor systems, devices, or devices, or any suitable combination of the foregoing. More specific examples of machine-readable storage medium may include electrical connections based on one or more lines, portable computer disks, hard disk, random access memory (RAM), read-only memory (ROM), erasable programmable read-only memory (EPROM or Flash memory), optical fiber, handy compact disk read-only memory (CD-ROM), optical storage devices, magnetic storage devices, or any suitable combination of the foregoing.

According to one or more embodiments of the present disclosure, an example provides a method of generating a spatial video, including:
shooting a first frame queue by a first camera and shooting a second frame queue by a second camera, where the first frame queue includes at least one first-eye video frame, and the second frame queue includes at least one second-eye video frame;
performing encoding processing on the first-eye video frame and the second-eye video frame to obtain media data of a target spatial video; and
generating a target video file of the target spatial video according to the media data and codec specific data of the target spatial video, where the codec specific data includes first-eye codec specific data and second-eye codec specific data.

According to one or more embodiments of the present disclosure, in an example of the method of the above example, where the generating a target video file of the target spatial video according to the media data and codec specific data of the target spatial video includes:
storing the media data into a media data chunk of the target video file; and
storing the codec specific data into a metadata block of the target video file in response to completion of storing the media data, to obtain the target video file of the target spatial video.

According to one or more embodiments of the present disclosure, in an example according to the method of the above example, the first-eye codec specific data and the second-eye codec specific data are stored in different configuration information sub-data chunk of the metadata block.

According to one or more embodiments of the present disclosure, in an example according to the method of the above example, where the media data includes continuous video frame data, where the performing encoding processing on the first-eye video frame and the second-eye video frame to obtain media data of a target spatial video, including:
determining a first-eye video frame currently to be encoded in the first frame queue and a second-eye video frame currently to be encoded in the second frame queue, where a timestamp of the first-eye video frame currently to be encoded and a timestamp of the second-eye video frame currently to be encoded match with each other; and
performing encoding processing on the first-eye video frame currently to be encoded to obtain a first-eye video frame data, and performing encoding processing on the second-eye video frame currently to be encoded to obtain a second-eye video frame data.

For example, the storing the media data into a media data chunk of the target video file includes:
packaging the first-eye video frame data and the second-eye video frame data into current video frame data of the target spatial video, and storing the current video frame data into the media data chunk of the target video file.

According to one or more embodiments of the present disclosure, in an example according to the method of the above example, before the determining a first-eye video frame currently to be encoded in the first frame queue and a second-eye video frame currently to be encoded in the second frame queue, further including:

Adding a first-eye identifier to the first-eye video frame in the first frame queue and adding a second-eye identifier to the second-eye video frame in the second frame queue.

According to one or more embodiments of the present disclosure, an example provides a method of playing a spatial video, including:
obtaining codec specific data and media data in a target video file, where the target video file is a video file of a target spatial video, and the codec specific data includes first-eye codec specific data and second-eye codec specific data;
performing decoding processing on the media data according to the codec specific data to obtain a first-eye video stream and a second-eye video stream, where video frames on same positions of the first-eye video stream and the second-eye video stream have timestamps that match with each other; and
playing the first-eye video stream on a first-eye display screen and playing the second-eye video stream on a second-eye display screen, where the first-eye video stream is played synchronously with the second-eye video stream.

According to one or more embodiments of the present disclosure, in an example according to the method of the above example, the obtaining codec specific data and media data in a target video file includes:
performing parsing on the metadata block of the target video file to obtain codec specific data of the target spatial video; and
performing parsing on the media data chunk of the target video file to obtain the media data of the target spatial video.

According to one or more embodiments of the present disclosure, in an example according to the method of the above example, the obtaining codec specific data of a target spatial video, including:
obtaining first-eye codec specific data of the target spatial video from a first configuration information sub-data chunk of the metadata block; and
obtaining second-eye codec specific data of the target spatial video from a second configuration information sub-data chunk of the metadata block.

According to one or more embodiments of the present disclosure, in an example according to the method of the above example, where performing decoding processing on the media data according to the codec specific data to obtain a first-eye video stream and a second-eye video stream, includes:
configuring a decoder according to the codec specific data; and
after completion of the configuring, performing decoding processing on the media data through the decoder to obtain a first-eye video stream and a second-eye video stream.

According to one or more embodiments of the present disclosure, in an example according to the method of the above example, where the media data includes continuous video frame data, where the performing decoding processing on the media data through the decoder to obtain a first-eye video stream and a second-eye video stream, including:
obtaining video frame data currently to be decoded according to an arrangement order of the video frame data;
splitting the video frame data currently to be decoded to obtain the first-eye video frame data currently to be decoded and the second-eye video frame data currently to be decoded; and
performing decoding processing on the first-eye video frame data currently to be decoded by the decoder to obtain one first-eye video frame in the first-eye video frame, and performing decoding processing on the second-eye video frame data currently to be decoded by the decode to obtain one second-eye video frame in the second-eye video frame.

According to one or more embodiments of the present disclosure, an example provides an apparatus for generating a spatial video, including:
a shooting module configured to shoot a first frame queue by a first camera and shooting a second frame queue by a second camera, where the first frame queue includes at least one first-eye video frame, and the second frame queue includes at least one second-eye video frame;
an encoding module configured to perform encoding processing on the first-eye video frame and the second-eye video frame to obtain media data of a target spatial video; and
a generation module configured to generate a target video file of the target spatial video according to the media data and codec specific data of the target spatial video, where the codec specific data includes first-eye codec specific data and second-eye codec specific data.

According to one or more embodiments of the present disclosure, an example provides an apparatus for playing spatial video, including:
an obtaining module configured to obtain codec specific data and media data in a target video file, where the target video file is a video file of a target spatial video, and the codec specific data includes first-eye codec specific data and second-eye codec specific data;
a decoding module configured to perform decoding processing on the media data according to the codec specific data to obtain a first-eye video stream and a second-eye video stream, where video frames on same positions of the first-eye video stream and the second-eye video stream have timestamps that match with each other; and
a display module configured to play the first-eye video stream on a first-eye display screen and play the second-eye video stream on a second-eye display screen, where the first-eye video stream is played synchronously with the second-eye video stream.

According to one or more embodiments of the present disclosure, an example provides an electronic device including:
at least one processor; and
a memory communicatively connected to the at least one processor,
where the at least one processor is configured to execute computer program stored in the memory to perform the method of generating a spatial video of any one of the above examples or the method of playing a spatial video of any one of the above examples.

According to one or more embodiments of the present disclosure, an example provides a computer-readable storage medium having computer program stored thereon, and when executed by a processor, the computer program implements the method of generating a spatial video of any one of the above examples or the method of playing a spatial video of any one of the above examples.

According to one or more embodiments of the present disclosure, an example provides a computer program product that, when the computer program product is executed by a computer, causes the computer to implement the method of generating a spatial video of any one of the above examples or the method of playing a spatial video of any one of the above examples.

The above description is merely an explanation of preferred embodiments of the present disclosure and the technical principles employed. Those skilled in the art should understand that the scope of disclosure in the present disclosure is not limited to technical solutions formed by specific combinations of the above-described technical feature rights, and should also cover other technical solutions formed by arbitrary combinations of the above-described technical feature rights or their equivalent features without departing from the concept of the above-described disclosure. For example, the above-described features are mutually replaced with technical feature having similar functions disclosed in the present disclosure (but not limited to).

Furthermore, while operations are depicted in a particular order, this should not be understood as requiring the operations to be performed in the particular order shown or in a sequential order. Under certain circumstances, multi-task and parallel processing may be advantageous. Likewise, while several specific implementation details are included in the above discussion, these should not be construed as limiting the scope of the present disclosure. Certain features described in the context of separate embodiments may also be implemented in combination in a single embodiment. Conversely, the various features described in the context of a single embodiment may also be implemented in multiple embodiments individually or in any suitable sub-combination.

Although the subject matter has been described in language specific to structural features and/or methodological logical acts, it should be understood that the subject matter defined in the appended claims is not necessarily limited to the specific features or acts described above. Rather, the specific features and acts described above are merely exemplary forms for implementing the claims.

1. A method of generating a spatial video, comprising:
shooting a first frame queue by a first camera and shooting a second frame queue by a second camera, wherein the first frame queue comprises at least one first-eye video frame, and the second frame queue comprises at least one second-eye video frame;
performing encoding processing on the first-eye video frame and the second-eye video frame to obtain media data of a target spatial video; and
generating a target video file of the target spatial video according to the media data and codec specific data of the target spatial video, wherein the codec specific data comprises first-eye codec specific data and second-eye codec specific data.

2. The method according to claim 1, wherein the generating a target video file of the target spatial video according to the media data and codec specific data of the target spatial video, comprises:
storing the media data into a media data chunk of the target video file; and
storing the codec specific data into a metadata block of the target video file in response to completion of storing the media data, to obtain the target video file of the target spatial video.

3. The method according to claim 2, wherein the first-eye codec specific data and the second-eye codec specific data are stored in different configuration information sub-data chunk of the metadata block.

4. The method according to claim 2, wherein the media data comprises continuous video frame data, wherein the performing encoding processing on the first-eye video frame and the second-eye video frame to obtain media data of a target spatial video, comprises:
determining a first-eye video frame currently to be encoded in the first frame queue and a second-eye video frame currently to be encoded in the second frame queue, wherein a timestamp of the first-eye video frame currently to be encoded and a timestamp of the second-eye video frame currently to be encoded match with each other; and
performing encoding processing on the first-eye video frame currently to be encoded to obtain a first-eye video frame data, and performing encoding processing on the second-eye video frame currently to be encoded to obtain a second-eye video frame data;
wherein the storing the media data into a media data chunk of the target video file comprises:
packaging the first-eye video frame data and the second-eye video frame data into current video frame data of the target spatial video, and storing the current video frame data into the media data chunk of the target video file.

5. The method according to claim 4, wherein, before the determining a first-eye video frame currently to be encoded in the first frame queue and a second-eye video frame currently to be encoded in the second frame queue, the method further comprises:
adding a first-eye identifier to the first-eye video frame in the first frame queue and adding a second-eye identifier to the second-eye video frame in the second frame queue.

6. A method of playing a spatial video, comprising:
obtaining codec specific data and media data in a target video file, wherein the target video file is a video file of a target spatial video, and the codec specific data comprises first-eye codec specific data and second-eye codec specific data;
performing decoding processing on the media data according to the codec specific data to obtain a first-eye video stream and a second-eye video stream, wherein video frames on same positions of the first-eye video stream and the second-eye video stream have timestamps that match with each other; and
playing the first-eye video stream on a first-eye display screen and playing the second-eye video stream on a second-eye display screen, wherein the first-eye video stream is played synchronously with the second-eye video stream.

7. The method according to claim 6, wherein the obtaining codec specific data and media data in a target video file comprises:
performing parsing on the metadata block of the target video file to obtain codec specific data of the target spatial video; and
performing parsing on the media data chunk of the target video file to obtain the media data of the target spatial video.

8. The method according to claim 7, wherein the obtain codec specific data of the target spatial video comprises:
obtaining first-eye codec specific data of the target spatial video from a first configuration information sub-data chunk of the metadata block; and
obtaining second-eye codec specific data of the target spatial video from a second configuration information sub-data chunk of the metadata block.

9. The method according to claim 6, wherein the performing decoding processing on the media data according to the codec specific data to obtain a first-eye video stream and a second-eye video stream, comprises:
configuring a decoder according to the codec specific data; and
after completion of the configuring, performing decoding processing on the media data through the decoder to obtain a first-eye video stream and a second-eye video stream.

10. The method according to claim 9, wherein the media data comprises continuous video frame data, wherein the performing decoding processing on the media data through the decoder to obtain a first-eye video stream and a second-eye video stream, comprises:
obtaining video frame data currently to be decoded according to an arrangement order of the video frame data;
splitting the video frame data currently to be decoded to obtain the first-eye video frame data currently to be decoded and the second-eye video frame data currently to be decoded; and
performing decoding processing on the first-eye video frame data currently to be decoded by the decoder to obtain one first-eye video frame in the first-eye video frame, and performing decoding processing on the second-eye video frame data currently to be decoded by the decode to obtain one second-eye video frame in the second-eye video frame.

11. An electronic device comprising:
at least one processor; and
a memory communicatively connected to the at least one processor, wherein the at least one processor is configured to execute computer program stored in the memory to perform a method of generating a spatial video, the method comprises:
shooting a first frame queue by a first camera and shooting a second frame queue by a second camera, wherein the first frame queue comprises at least one first-eye video frame, and the second frame queue comprises at least one second-eye video frame;
performing encoding processing on the first-eye video frame and the second-eye video frame to obtain media data of a target spatial video; and
generating a target video file of the target spatial video according to the media data and codec specific data of the target spatial video, wherein the codec specific data comprises first-eye codec specific data and second-eye codec specific data.

12. The electronic device according to claim 11, wherein the generating a target video file of the target spatial video according to the media data and codec specific data of the target spatial video, comprises:
storing the media data into a media data chunk of the target video file; and
storing the codec specific data into a metadata block of the target video file in response to completion of storing the media data, to obtain the target video file of the target spatial video.

13. The electronic device according to claim 12, wherein the first-eye codec specific data and the second-eye codec specific data are stored in different configuration information sub-data chunk of the metadata block.

14. The electronic device according to claim 12, wherein the media data comprises continuous video frame data, wherein the performing encoding processing on the first-eye video frame and the second-eye video frame to obtain media data of a target spatial video, comprises:
determining a first-eye video frame currently to be encoded in the first frame queue and a second-eye video frame currently to be encoded in the second frame queue, wherein a timestamp of the first-eye video frame currently to be encoded and a timestamp of the second-eye video frame currently to be encoded match with each other; and
performing encoding processing on the first-eye video frame currently to be encoded to obtain a first-eye video frame data, and performing encoding processing on the second-eye video frame currently to be encoded to obtain a second-eye video frame data;
wherein the storing the media data into a media data chunk of the target video file comprises:
packaging the first-eye video frame data and the second-eye video frame data into current video frame data of the target spatial video, and storing the current video frame data into the media data chunk of the target video file.

15. The electronic device according to claim 14, wherein, before the determining a first-eye video frame currently to be encoded in the first frame queue and a second-eye video frame currently to be encoded in the second frame queue, the processor is further configured to:
adding a first-eye identifier to the first-eye video frame in the first frame queue and adding a second-eye identifier to the second-eye video frame in the second frame queue.

16. A non-transitory computer-readable storage medium, wherein computer instructions are stored on the computer-readable storage medium to cause a processor to execute the method of generating the spatial video according to claim 1.

17. The non-transitory computer-readable storage medium according to claim 16, wherein the generating a target video file of the target spatial video according to the media data and codec specific data of the target spatial video, comprises:
storing the media data into a media data chunk of the target video file; and
storing the codec specific data into a metadata block of the target video file in response to completion of storing the media data, to obtain the target video file of the target spatial video.

18. The non-transitory computer-readable storage medium according to claim 17, wherein the first-eye codec specific data and the second-eye codec specific data are stored in different configuration information sub-data chunk of the metadata block.

19. The non-transitory computer-readable storage medium according to claim 17, wherein the media data comprises continuous video frame data, wherein the performing encoding processing on the first-eye video frame and the second-eye video frame to obtain media data of a target spatial video, comprises:
determining a first-eye video frame currently to be encoded in the first frame queue and a second-eye video frame currently to be encoded in the second frame queue, wherein a timestamp of the first-eye video frame currently to be encoded and a timestamp of the second-eye video frame currently to be encoded match with each other; and
performing encoding processing on the first-eye video frame currently to be encoded to obtain a first-eye video frame data, and performing encoding processing on the second-eye video frame currently to be encoded to obtain a second-eye video frame data;
wherein the storing the media data into a media data chunk of the target video file comprises:
packaging the first-eye video frame data and the second-eye video frame data into current video frame data of the target spatial video, and storing the current video frame data into the media data chunk of the target video file.

20. The non-transitory computer-readable storage medium according to claim 19, wherein, before the determining a first-eye video frame currently to be encoded in the first frame queue and a second-eye video frame currently to be encoded in the second frame queue, the processor is further configured to:
adding a first-eye identifier to the first-eye video frame in the first frame queue and adding a second-eye identifier to the second-eye video frame in the second frame queue.
